(19) United States
(12) Patent Application Publication
(10) Pub. No.: US 2008/0016215 A1
(43) Pub. Date: Jan. 17, 2008

(54) IP address pools for device configuration

(76) Inventors: Daniel E. Ford, Roseville, CA (US); Scott A. Gulland, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/485,795

(22) Filed: Jul. 13, 2006

(51) Int. Cl. G06F 15/173

(52) U.S. Cl. 709/226

(57) ABSTRACT

Methods, computer readable media, and system embodiments are provided for device configuration. One method embodiment includes defining a pool of Internet Protocol (IP) addresses having a pool name, defining a device configuration template having a tag that identifies the pool name, and substituting an IP address from the pool of IP addresses for the tag in the device configuration template to create a device configuration file.

### BACKGROUND

Computing systems can include multiple computing components such as servers, desktop PCs, laptops, and workstations, among other peripheral devices, (e.g., printers, facsimile devices, and scanners). In some systems, these components can be networked together across a local area network (LAN) and/or wide area network (WAN). A LAN and/or WAN uses clients and servers that have network-enabled operating systems such as Windows, Mac, Linux, and Unix.

An example of a client includes a user's workstation, among other types of devices. Servers can hold programs and data that are shared by the clients in a computing network. Servers can come in a wide range of capacities and costs, from Intel-based PC servers to mainframes. Peripherals, such as a printer, facsimile device, and/or scanner can be attached locally to a workstation or to a server and be shared by network users.

Data transfer between components over a network can be managed by a transport protocol such as Transmission Control Protocol/Internet Protocol (TCP/IP), among others. The Internet Protocol (IP) layer in TCP/IP contains a network address and allows messages to be routed to a different network or subnetwork (subnet). The physical transmission of such data can be performed by an access method, typically via Ethernet, which can be provided on the motherboard or in the network adapter cards (NICs) plugged into the network devices. The actual communications path can be a twisted pair or optical fiber cable that interconnects each network adapter.

Network components can include Ethernet ports for home use, not just to create a small home network, but to connect to the Internet via a DSL or cable modem. An Ethernet port typically can support both 10BaseT at 10 megabits per second (Mbps) and 100BaseT at 100 Mbps, among other data transmission modes.

Network components in a LAN and/or WAN can include hardware components, such as trunk lines, switches, routers, hubs, servers, and databases. LANs and/or WANs can also include instructions such as software, application modules, firmware, and various types of computer executable instructions.

Network components such as switches, hubs, and routers, for example, are used to distribute and restrict traffic within workgroups of a network. Network components can also provide filtering of inter or intra network traffic for security purposes and policy management. These sorts of network component functionality can also be incorporated into other components within a network environment, such a file server, a load balancing device or other such network appliance.

Any number of network components, such as those mentioned above, may be included in a network. These network components will be generally referred to herein as network devices. When such network devices are added to the network, the device typically has to be configured for use in the network environment. This typically means configuring the software, firmware, and other instructions on the device to communicate with the other network devices.

As a part of this configuration, many devices are assigned an IP address. These addresses are typically different from the IP addresses of the other devices of the network and different from the IP addresses of the devices of other networks. In such instances, at least a portion of the configuration of each such device has typically had to have been performed manually. This is because such unique IP addresses have had to have been identified, entered into each device, and the assignment noted by the network.

In some instances, this manual configuration may result in duplicate assignment of IP addresses, skipping of addresses that may be available for assignment. Such configuration methods may also be time consuming, particularly for network administrators that do not add devices to their network often.

### BRIEF DESCRIPTION OF THE DRAWINGS

FIG. 1A illustrates a communication network with which embodiments of the present disclosure can be implemented.

FIG. 1B illustrates another communication network with which embodiments of the present disclosure can be implemented.

FIG. 2 is a block diagram of a computing device that can be utilized with the embodiments of the present disclosure.

FIG. 3 is a block diagram illustrating an embodiment of a method according to an embodiment of the present disclosure.

### DETAILED DESCRIPTION

Embodiments of the present disclosure include devices, methods, and computer readable media for configuring devices. For example, one method embodiment includes defining a pool of Internet Protocol (IP) addresses having a pool name, defining a device configuration template having a tag that identifies the pool name, and substituting an IP address from the pool of IP addresses for the tag in the device configuration template to create a device configuration file.

Embodiments of the present disclosure and features thereof can be performed by software, firmware, hardware, application modules, and the like. These embodiments can use instructions resident on and/or executable by circuits such as Application Specific Integrated Circuits (ASICs), devices, systems, or networks shown herein or otherwise.

The embodiments of the present disclosure are not limited to any particular operating environment or to instructions written in any particular programming language. Software, firmware, and/or processing modules, suitable for carrying out embodiments of the present disclosure, can be resident on one or more devices in one or more locations.

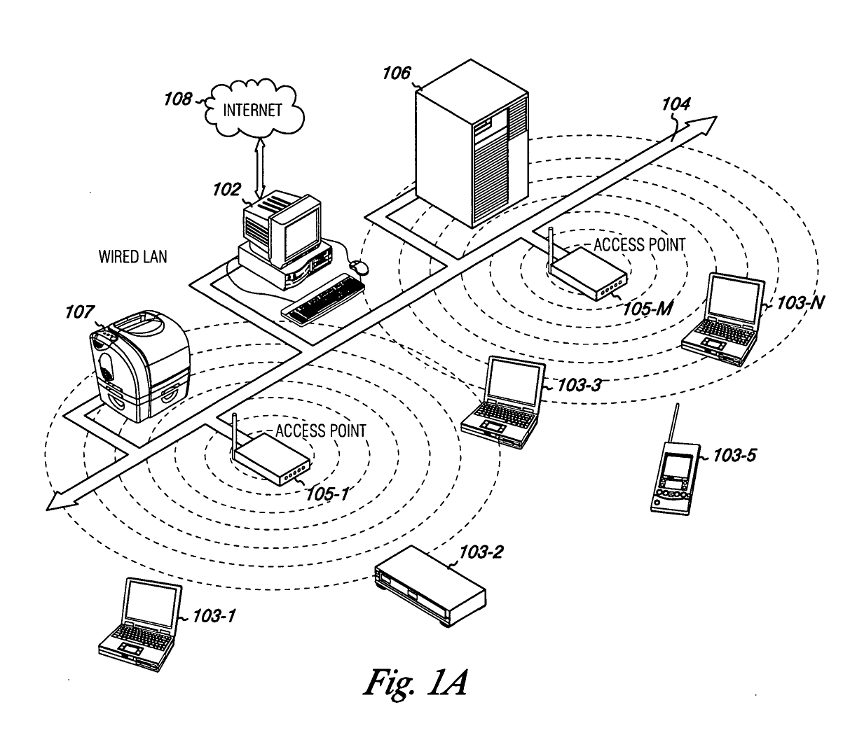

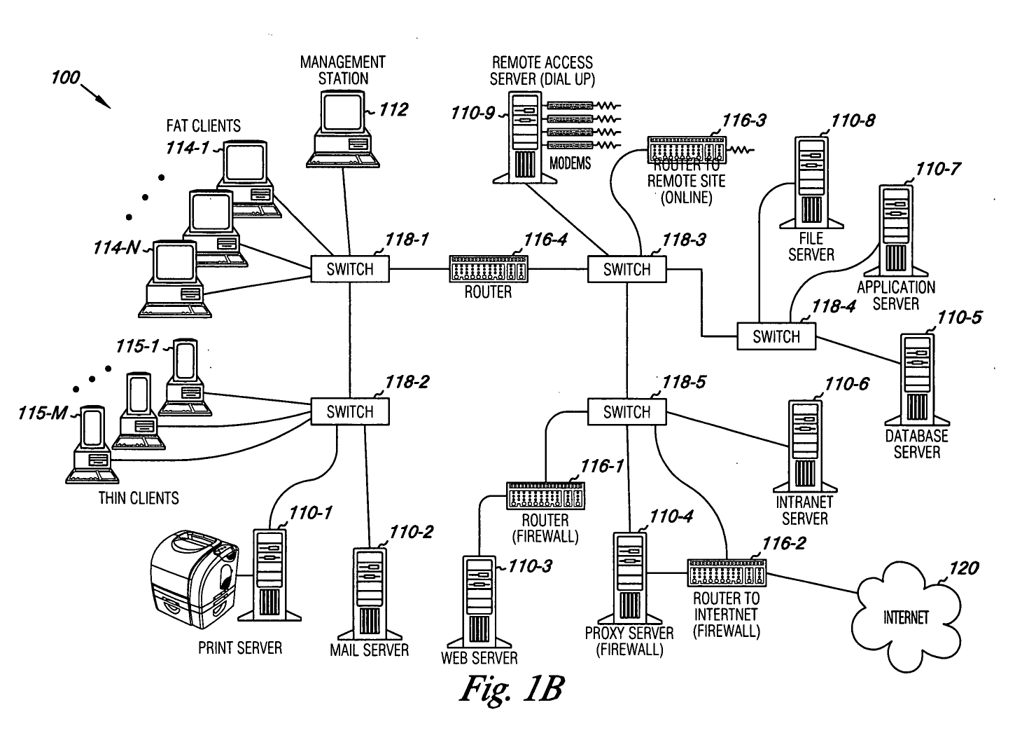

FIG. 1A illustrates a communication network with which embodiments of the present disclosure can be implemented. FIG. 1A illustrates a network infrastructure including wireless access points (e.g., points 105-1, . . . , 105-M).

FIG. 1A illustrates a computing device 102 coupled over a LAN and/or WAN to a number of network devices using both hardwired and wireless connections. In FIG. 1A, multiple computing devices 103-1, 103-2, 103-3, 103-4, . . . , 103-N, are illustrated connected via wireless access points, 105-1 and 105-2, to the LAN and the computing device 102.

The designators “N” and “M” are used to indicate that a number of access points and/or multimedia devices can be attached to the network. The number that N represents can be the same or different from the number represented by M.

The devices, 103-1, 103-2, 103-3, 103-4, . . . , 103-N, can include a number and variety devices as the same have been described above. The computing devices, 103-1, 103-2, 103-3, 103-4, . . . , 103-N, can connect to the access points, 105-1, . . . , 105-M, according to a number of different wireless protocols (e.g., via RF, 802.11 standards and/or Bluetooth, among others).

The computing device 102 is illustrated connected to a server/database 106 over a hardwired network connection 104. A peripheral 107 such as a multifunction scanner, copier, and/or facsimile device is also shown connected to the computing device 102 in a hardwired manner.

FIG. 1A further illustrates that the computing device 102 may have access to the Internet 108. This may be one method of accessing other networks or devices. Other methods can include various other wired and wireless connections.

Configuration files can be provided to the computing devices 103-1, 103-2, 103-3, 103-4, . . . , 103-N in various manners. For example, one or more configuration files can be downloaded from the computing device 102 over the wired and/or wireless network infrastructure.

In such instances, the network could employ a particular software interface application to download the one or more files (e.g., an initial and/or subsequent configuration) from the computing device 102 through the hardwired network connection 104 and access points, 105-1, . . . , 105-M, to respective memories among the various number and types of computing devices, 103-1, 103-2, 103-3, 103-4, . . . , 103-N. This process can involve the use of a management utility as well as configuration and setup for both the hardware and software.

The management utility can be functional to manage some or all aspects of the network. Information to be configured can include, for example a baud rate, stop bit, and/or IP address, etc.

The configuration of a device can be accomplished, for example, by defining one or more pools of Internet Protocol (IP) addresses. Each of these pools can have a name associated therewith. The name can also serve as a tag within various documents.

The tag can then be used to link the information contained in the pool with the tag. The tag can, for example, be a Java or XML type tag that can be used by such software to identify the information contained in the pool.

Since the tag can be used to create an association with the information in the pool, it can be used to identify where some information within the pool is to be placed within a document. For example, the configuration can also include defining a device configuration template having a tag that identifies the pool name.

In such instances, the tag can be placed in one or more positions within the document and the appropriate information (e.g., an IP address) can be substituted into the document for the tag. For instance, configuration can be accomplished by substituting an IP address from the pool of IP addresses for the tag in the device configuration template to create a device configuration file. In such manners, a general device configuration template can be created. The template can then be modified and saved as a device configuration file that can be specialized for a particular device to be configured.

With respect to the configuration of device IP addresses, the use of a template can allow for more rapid, and in some instances automatic, assignment of IP addresses to one or more devices. Also, by using a pool of addresses, the addresses that are used and/or unused can be tracked. This can be accomplished by using an identifier to (e.g., a mark such as a tag) to indicate the status of an IP address, such as, for example, whether the address has been used and/or unused, among other status indications.

In some embodiments instructions can be executed for deploying multiple device configuration files created by the substitution of a different IP address from the pool of IP addresses for each tag in a number of copies of the device configuration template to create a number of device configuration files. In such embodiments, instructions can also be executed for deploying each device configuration file into a different device to be configured.

In various embodiments, multiple tags can be defined for designating multiple different pools of IP addresses. In such embodiments, the tags can represent a variety of differentiating characteristics of the pools or the information contained therein. For example, in various embodiments, each of the multiple tags can be a subnet mask.

In some embodiments, each of the multiple pools has a different subnet mask. Some embodiments can include instructions for defining multiple device configuration templates each corresponding to a different subnet.

Such embodiments can also have a template that has the tag provided therein in a position into which an IP address is to be positioned. In this way, an IP address from the pool of IP addresses can be substituted for the tag in the device configuration template to create a device configuration file.

In various embodiments, each of the pools of IP addresses is associated with a different subnet and instructions are provided for substituting an IP address from a pool of IP addresses that is associated with a particular one of the subnets for the tag in the device configuration template to create a device configuration file.

In various embodiments, instructions can also be provided for adjusting the number of IP addresses in a pool of IP addresses. Embodiments can also include instructions for suggesting a number of IP addresses that are to be designated to a pool of IP addresses.

The IP addresses can be organized in a variety of manners. For example, the pool of IP addresses can include a number of sequential and/or non-sequential IP addresses.

In some embodiments, the pool of IP addresses can include a range of IP addresses. In such embodiments, each address may be provided in a file, such as in the form of a list, or the range can be provided and a logic algorithm can be used to assign the actual IP addresses based upon those addresses that would logically fall within the range. Such algorithms can also be utilized to identify and track the use of the various IP addresses in the one or more pools that may be defined in various embodiments.

In some embodiments, the device can include a number of executable instructions including instructions for defining a tag for designating a pool of Internet Protocol (IP) addresses. Such embodiments can also have instructions for defining a device configuration template having the tag provided therein in a position into which an IP address is to be positioned.

Such embodiments can also include instructions for substituting an IP address from the pool of IP addresses for the tag in the device configuration template to create a device configuration file. These files can be deployed to a device to be configured.

In such embodiments, a number of instructions can be provided to deploy multiple device configuration files created by the substitution of a different IP address from the pool of IP addresses for each tag in a number of copies of the device configuration template to create a number of device configuration files. These device configuration files can each be deployed into a different device to be configured.

In this way, each device can have a different configuration file. However, through use of the same starting device configuration template, the devices will each be able to have similarities in their configuration files as well as differences.

Such configuration capabilities can be provided as stand alone set of instructions, in program applications, and can be implemented by a variety of computing devices. For example, the number of instructions to deploy multiple device configuration files can be included in a system management application, which can be provided on a management station or some other network device.

FIG. 1B illustrates another communication network with which embodiments of the present disclosure can be implemented. As shown in FIG. 1B, a number devices can be networked together via a LAN and/or WAN via router, hubs, switches, and the like. The embodiment of FIG. 1B illustrates a number of clients and servers in a LAN. However, embodiments of the disclosure are not so limited.

The embodiment illustrates a server for each type of service on a LAN. However, in practice several functions can be combined in one device or machine and, for large volumes, multiple devices or machines can be used to balance the traffic for the same service. For example, an enterprise system or network can include a collection of servers, or server farm, cooperating to provide services to the network.

Thus, FIG. 1B illustrates a communication network 100 having a print server 110-1 to handle print jobs for the network 100, a mail server 110-2, a web server 110-3, a proxy server (firewall) 110-4, a database server 110-5, and intranet server 110-6, an application server 110-7, a file server 110-8, and a remote access server (dial up) 110-9. Again, the examples provided here do not provide an exhaustive list.

The embodiment of FIG. 1B further illustrates a network management station 112 (e.g., a PC or workstation) a number of “fat” clients, which can include PCs and workstations and/or laptops, and a number of “thin” clients, which can include terminals and/or peripherals, such as scanners, facsimile devices, handheld multifunction devices, and the like. The embodiment of FIG. 1B, also illustrates that all of these devices can be connected to one another and/or to other networks via routers, 116-1, 116-2, 116-3, and 116-4, and/or hubs and/or switches 118-1, 118-2, 118-3, 118-4, and 118-5. In some embodiments, device configuration files can be forwarded to the routers and/or switches of the network, among other devices of the network.

Many of these devices include processor and memory hardware. By way of example and not by way of limitation, the network management station 112 can include a processor and memory. Embodiments of the disclosure are not limited, to the various exemplary devices illustrated in FIG. 1B, or to the number, type or size of processor and/or memory resources.

Program applications (e.g., computer executable instructions) can reside on a network management station to manage and/or monitor a network. Managing and/or monitoring a network can include instructions for the configuration of new and/or existing devices connected to the network.

The various devices attached to the network 100 can have their socket connection's IP address and/or port number mapped within the network 100 (e.g., mapped to the network management station and stored in a memory directory or database on the network management station or elsewhere at a known location in a distributed network). An IP address and/or a port number of a socket connection can be mapped within a network, for example, based upon network device connection routines, as devices are connected to the network.

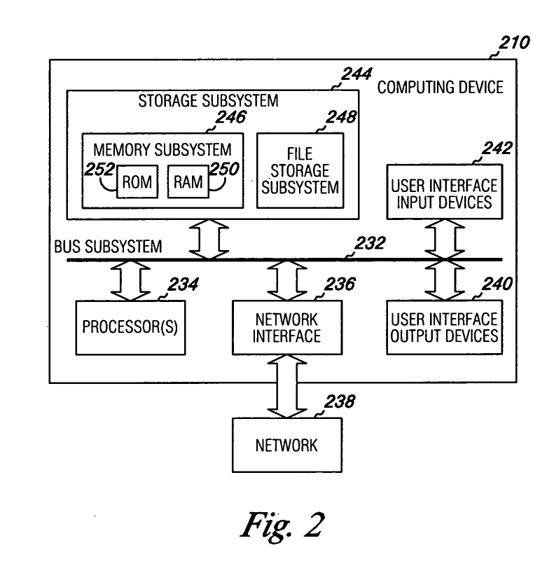

FIG. 2 is a block diagram of a computing device that can be utilized with the embodiments of the present disclosure. Computing device 210 includes one or more processors 234 that communicate with a number of other computing components via bus subsystem 232.

These other computing components may, for example, include a storage subsystem 244 having a memory subsystem 246 and a file storage subsystem 248, user interface input devices 242, user interface output devices 240, and a network interface subsystem 236, to name a few. The input and output devices allow user interaction with computing device 210.

Network interface subsystem 236 provides an interface to outside networks, including an interface to network 238 (e.g., a LAN, WAN, Internet, and/or wireless network, among others), and is coupled via network 238 to corresponding interface devices in other computer systems or devices. Network 238 may itself include many interconnected computer systems and communication links. Communication links as used herein may be hardwire links, optical links, satellite, or other wireless communications links, wave propagation links, or any other mechanisms for communication of information.

User interface input devices 242 may include a keyboard; pointing devices such as a mouse, trackball, touchpad, or graphics tablet, a scanner, a touchscreen incorporated into a display; audio input devices such as voice recognition systems, microphones, and other types of input devices. In general, use of the term “input device” is intended to include all possible types of devices and ways to input information into computer system 210 or onto computer network 238.

User interface output devices 240 may include a display subsystem, a printer, a fax machine, or non-visual displays such as audio output devices. In general, use of the term “output device” is intended to include all possible types of devices and ways to output information from computer system 210 to a user or to another machine or computer system 210.

Storage subsystem 244 can include the operating system “kernel” layer and an application layer to enable the device to perform various functions, tasks, or roles. File storage subsystem 248 can provide persistent (e.g., non-volatile) storage for additional program and data files, and may include a hard disk drive, a floppy disk drive along with associated removable media, a Compact Digital Read Only Memory (CD-ROM) drive, an optical drive, or removable media cartridges. Memory subsystem 246 typically includes a number of memory components including a main Random Access Memory (RAM) 230 for storage of program instructions and data, e.g., application programs, during program execution and a Read Only Memory (ROM) 232 in which fixed instructions, e.g., operating system and associated kernel, are stored.

As used herein, a computer readable medium is intended to include the types of memory described above. Program embodiments as will be described further herein can be included with a computer readable medium and may also be provided using a carrier wave over a communications network such as the Internet, among others. Bus subsystem 232 provides a mechanism for letting the various components and subsystems of computer system 210 communicate with each other as intended.

Program embodiments according to the present invention can be stored in the memory subsystem 246, the file storage subsystem 248, and/or elsewhere in a distributed computing environment. Due to the ever-changing nature of computing devices and networks, the description of computing device 210 depicted in FIG. 2 is intended only as one example of a computing environment suitable for implementing embodiments of the present disclosure. Many other configurations of computer system 210 are possible having more or less components than the computing device depicted in FIG. 2.

In various embodiments, a configuration device can include, for example, a processor and memory having a number of instructions that are executable by the processor. The configuration device can be a system management station or other network device.

In some embodiments, the memory can include instructions for a variety of functions provided by the network, the network management station, and/or the computing device on which the instructions reside. The instructions provided can include instructions executable to manage implement the functionality described herein with respect to configuring devices. For example, instructions can be provided to define a number of tags each associated with a different pool of Internet Protocol (IP) addresses.

In some such embodiments, instructions can also be provided to define a device configuration template having at least one of the number of tags provided therein in a position into which an IP address is to be positioned. Executable instructions can also be utilized to substitute each of the tags in the device configuration template with an IP address from its associated pool of IP addresses to create a device configuration file.

In some embodiments, the device configuration template can include multiple instances of the same tag and wherein the same IP address in substituted for each instance of the tag. In various devices, the device configuration template includes multiple instances of the same tag and wherein each instance of the tag is substituted with a different IP address from the pool associated with the tag. Such functionalities can be provided among the others discussed herein, in various embodiments.

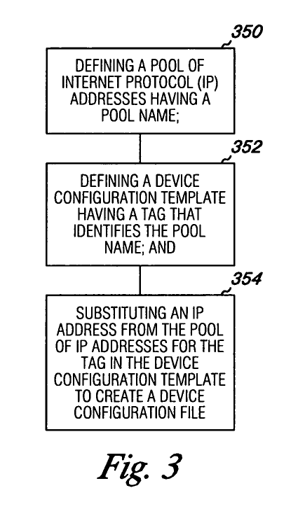

FIG. 3 is a block diagram illustrating an embodiment of a method of device configuration according to an embodiment of the present disclosure. As illustrated at block 350 the method of FIG. 3 includes defining a pool of Internet Protocol (IP) addresses having a pool name.

The methods discussed herein can be performed by software, application modules, and/or executable instructions operable on the systems and/or devices shown herein or otherwise. The embodiments, however, are not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments can occur or be performed at the same point in time.

As shown at block 352, the method of FIG. 3 also includes defining a device configuration template having a tag that identifies the pool name. The method of FIG. 3 also includes substituting an IP address from the pool of IP addresses for the tag in the device configuration template to create a device configuration file, at block 354.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the present disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method comprising:
defining a pool of Internet Protocol (IP) addresses having a pool name;
defining a device configuration template having a tag that identifies the pool name; and
substituting an. IP address from the pool of IP addresses for the tag in the device configuration template to create a device configuration file.

2. The method of claim 1, wherein the method includes;
deploying multiple device configuration files created by the substitution of a different IP address from the pool of IP addresses for each tag in a number of copies of the device configuration template to create a number of device configuration files; and
deploying each device configuration file into a different device to be configured.

3. The method of claim 1, wherein the method includes adjusting the number of IP addresses in a pool of IP addresses.

4. The method of claim 1, wherein the method includes suggesting a number of IP addresses that are to be designated to a pool of IP addresses.

5. The method of claim 1, wherein the method includes at least one of the IP addresses in a pool of IP addresses with a status indicator.

6. The method of claim 1, wherein tag that identifies the pool name is an XML tag.

7. The method of claim 1, wherein the pool of IP addresses includes a number of sequential IP addresses.

8. The method of claim 1, wherein the pool of IP addresses includes a range of IP addresses.

9. A computer readable medium, having instructions for causing a device to perform a method, comprising:
defining a tag for designating a pool of Internet Protocol (IP) addresses;
defining a device configuration template having the tag provided therein in a position into which an IP address is to be positioned; and
substituting an IP address from the pool of IP addresses for the tag in the device configuration template to create a device configuration file.

10. The medium of claim 9, wherein the method includes deploying the device configuration file to a device to be configured.

11. The medium of claim 9, wherein the method includes;
providing a number of instructions to deploy multiple device configuration files created by the substitution of a different IP address from the pool of IP addresses for each tag in a number of copies of the device configuration template to create a number of device configuration files; and
deploying each device configuration file into a different device to be configured.

12. The medium of claim 11, wherein the number of instructions to deploy multiple device configuration files are included in a system management application.

13. The medium of claim 9, wherein the method includes defining multiple tags for designating multiple different pools of IP addresses.

14. The medium of claim 13, wherein each of the multiple tags is a subnet mask.

15. The medium of claim 13, wherein the each of the multiple pools has a different subnet mask.

16. The medium of claim 13, wherein the method includes defining multiple device configuration templates each corresponding to a different subnet and wherein the template has the tag provided therein in a position into which an IP address is to be positioned; and
substituting an IP address from the pool of IP addresses for the tag in the device configuration template to create a device configuration file.

17. The medium of claim 13, wherein each of the pools of IP addresses is associated with a different subnet and wherein the method includes substituting an IP address from a pool of IP addresses that is associated with a particular one of the subnets for the tag in the device configuration template to create a device configuration file.

18. A configuration device comprising:
a processor;
memory having a number of instructions that are executable by the processor, the instructions provided to:
define a number of tags each associated with a different pool of Internet Protocol (IP) addresses;
define a device configuration template having at least one of the number of tags provided therein in a position into which an IP address is to be positioned; and
substitute each of the tags in the device configuration template with an IP address from its associated pool of IP addresses to create a device configuration file.

19. The device of claim 18, wherein the device configuration template includes multiple instances of the same tag and wherein the same IP address in substituted for each instance of the tag.

20. The device of claim 18, wherein the device configuration template includes multiple instances of the same tag and wherein each instance of the tag is substituted with a different IP address from the pool associated with the tag.
